(19) United States
(12) Patent Application Publication
(10) Pub. No.: US 2024/0224188 A1
(43) Pub. Date: Jul. 4, 2024

(54) ADAPTIVE ENERGY MANAGEMENT FOR WEB APPLICATIONS

(71) Applicant: SAP SE, Walldorf (DE)

(72) Inventors: Roman Rommel, Neustadt (DE); Jan-Michel Blinn, Osthofen (DE)

(21) Appl. No.: 18/092,545

(22) Filed: Jan. 3, 2023

(51) Int. Cl. H04W 52/02; H02J 7/00

(52) U.S. Cl. CPC H04W 52/0261; H02J 7/0048

(57) ABSTRACT

Web applications are run on a wide variety of devices, many of which are battery powered. Using modern web standards, it is possible to gain information about the battery level and charging state. This information may be used to adjust the operation of web applications. For example, applications can access the battery level of a device to calculate if there is enough remaining energy to complete the current task. If not, the application can react by offering several options such as charging the device for a specific amount of time or changing the energy source. The user may be notified once the battery is charged sufficiently. Data may be lost if power is lost before data is saved. Accordingly, monitoring the battery level may enable an application to save data or prompt a user to save data when the battery level reaches a predetermined threshold.

### TECHNICAL FIELD

The subject matter disclosed herein generally relates to web applications. Specifically, the present disclosure addresses systems and methods to modify the functionality of web applications for adaptive energy management.

### BACKGROUND

Web applications run on a wide variety of devices, many of which are battery powered. Client-side calculations may be performed that consume battery power. The battery of the device may be depleted before the calculations are complete.

### BRIEF DESCRIPTION OF THE DRAWINGS

Some embodiments are illustrated by way of example and not limitation in the figures of the accompanying drawings.

FIG. 1 is a network diagram illustrating a network environment suitable for adaptive energy management for web applications, according to some example embodiments.

FIG. 2 is a block diagram of an application server, according to some example embodiments, suitable for adaptive energy management for web applications.

FIG. 3 is a block diagrams of a database schema, according to some example embodiments, suitable for use in adaptive energy management for web applications.

FIG. 4 is a block diagram of a user interface suitable for adaptive energy management for web applications, according to some example embodiments.

FIG. 5 is a block diagram of a user interface suitable for adaptive energy management for web applications, according to some example embodiments.

FIG. 6 is a block diagram of a user interface suitable for adaptive energy management for web applications, according to some example embodiments.

FIG. 7 is a flowchart illustrating operations of a method suitable for adaptive energy management for web applications, according to some example embodiments.

FIG. 8 is a block diagram showing one example of a software architecture for a computing device.

FIG. 9 is a block diagram of a machine in the example form of a

computer system within which instructions may be executed for causing the machine to perform any one or more of the methodologies discussed herein.

### DETAILED DESCRIPTION

Example methods and systems are directed to adaptive energy management for web applications. Web applications are run on a wide variety of devices, many of which are battery powered. Using modern web standards, it is possible to gain information about the battery level and charging state. This information may be used to adjust the operation of web applications.

For example, applications can access the battery level of a device to calculate if there is enough remaining energy to complete the current task. If not, the application can react by offering several options such as charging the device for a specific amount of time or changing the energy source. The user may be notified once the battery is charged sufficiently. Alternative energy sources may include changing the battery, connecting to a power pack, or plugging into a wall socket.

Data may be lost if power is lost before data is saved. Accordingly, monitoring the battery level may enable an application to save data or prompt a user to save data when the battery level reaches a predetermined threshold. The user may also be advised to transfer the current task to another device.

When these effects are considered in aggregate, one or more of the methodologies described herein may increase the reliability of web applications executing on battery-powered devices.

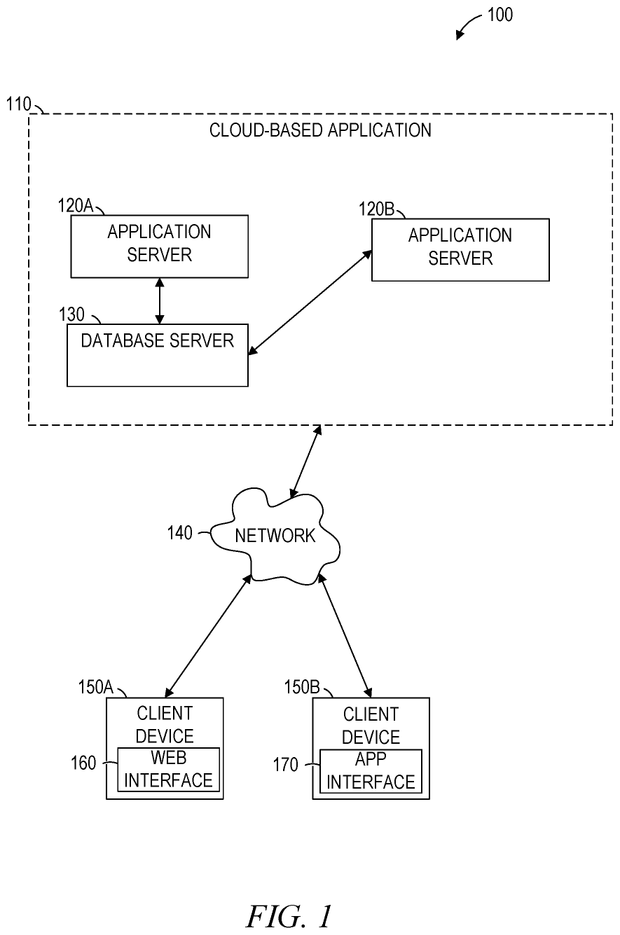

FIG. 1 is a network diagram illustrating a network environment 100 suitable for adaptive energy management for web applications, according to some example embodiments. The network environment 100 includes a cloud-based application 110, client devices 150A and 150B, and a network 140. The cloud-based application 110 is provided by application servers 120A and 120B in communication with a database server 130.

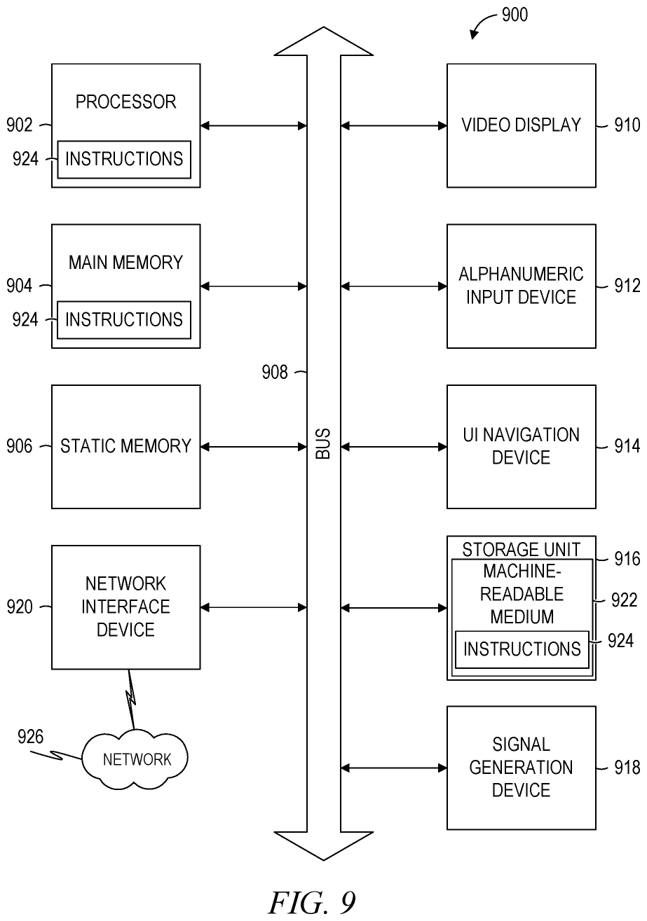

Reference numbers may be used without letter suffixes to refer to the corresponding components generically or in the aggregate. For example, “a client device 150” refers generically to either the client device 150A or the client device 150B and “the client devices 150” refers to the client devices 150A and 150B in the aggregate. By way of example and not limitation, FIG. 1 shows one cloud-based application 110, two application servers 120, one database server 130, and two client devices 150. In various implementations, multiple cloud-based applications 110 may be provided to any number of client devices 150 using any number of application servers 120 and database servers 130. The application servers 120, the database server 130, and the client devices 150 may each be implemented in a computer system, in whole or in part, as described below with respect to FIG. 9.

The application servers 120A-120B access application data (e.g., application data stored by the database server 130) to provide one or more applications to the client devices 150A and 150B via a web interface 160 or an application interface 170. For example, the application server 120A may provide a web application that receives requests from the client devices 150 and provides instructions for execution on the requesting client device 150.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 120, the database server 130, and the client devices 150 are connected by the network 140. The network 140 may be any network that enables communication between or among machines, databases, and devices. Accordingly, the network 140 may be a wired network, a wireless network (e.g., a mobile or cellular network), or any suitable combination thereof. The network 140 may include one or more portions that constitute a private network, a public network (e.g., the Internet), or any suitable combination thereof.

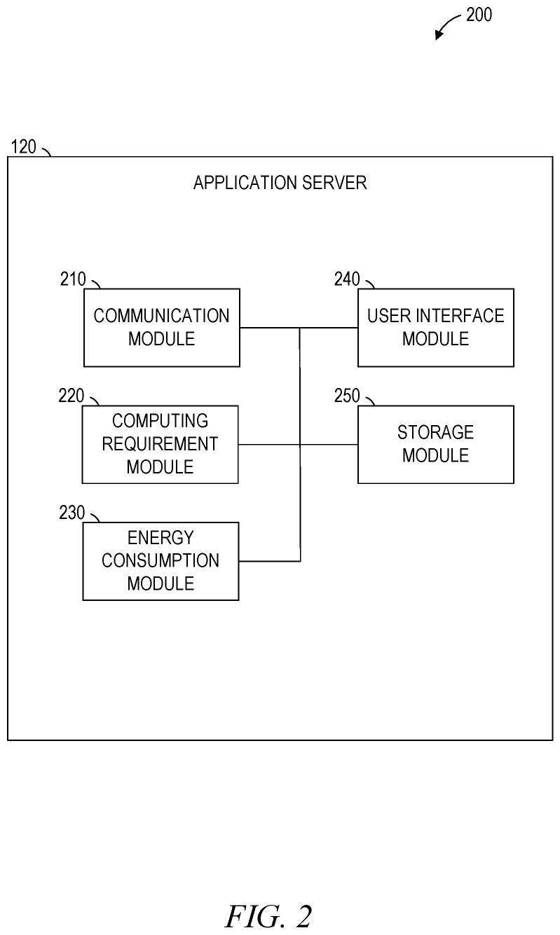

FIG. 2 is a block diagram 200 of an application server 120, according to some example embodiments, suitable for adaptive energy management for web applications. The application server 120 is shown as including a communication module 210, a computing requirement module 220, an energy consumption module 230, a user interface module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the application server 120 and transmits data from the application server 120. For example, the communication module 210 may receive, from the database server 130, data indicating the power consumption for a task running on a client device 150. As another example, the communication module 210 may receive, from the client device 150A, a request to perform a task. Data may be stored in local storage of the application server 120 via the storage module 250. Communications sent and received by the communication module 210 may be intermediated by the network 140.

The computing requirement module 220 may determine, based on data received from the database server 130, computing requirements for a task requested by a client device 150. For example, the client device 150 may request to perform a data analysis task. The task may be associated with a number of records associated with an account of a user of the client device 150. For example, the account may be an account of a tenant having 100,000 records to process. The computing requirements for the task may be based on the number of records to be processed. For example, an estimate of 1 billion CPU clock cycles for each record may be used, resulting in 100 billion clock cycles for the request. The request for the same task by a different account may have different computing requirements due to differences between the accounts. For example, the different account may have only 1,000 records to process.

The energy consumed by the task may be estimated by the energy consumption module 230. For example, the CPU clock cycles may be converted to a percentage of battery charge based on device-specific information about the client device 150 that will perform the task. Factors that impact the energy consumption estimate include the operating voltage of the CPU, the chipset of the CPU, the maximum charge of the battery, the operating system of the client device 150, network usage of the task to be performed, or any suitable combination thereof.

A user interface may be provided by the user interface module 240. For example, the user interface module 240 may send, via the communication module 210, HTML files over the network 140 to the client device 150A. The web interface 160 (e.g., a web browser) of the client device 150A renders the user interface and sends data regarding user interactions with the user interface back to the user interface module 240. The user interface may include information about the energy consumption of a requested task, a recommendation relating to the energy consumption of the requested task (e.g., a recommendation to charge a battery for an identified duration of time, a recommendation to change a power source of the device, or both), or any suitable combination thereof.

The storage module 250 may store data locally on the application server 120 (e.g., in a hard drive) or store data remotely. Examples of remote storage include network storage devices and the database server 130.

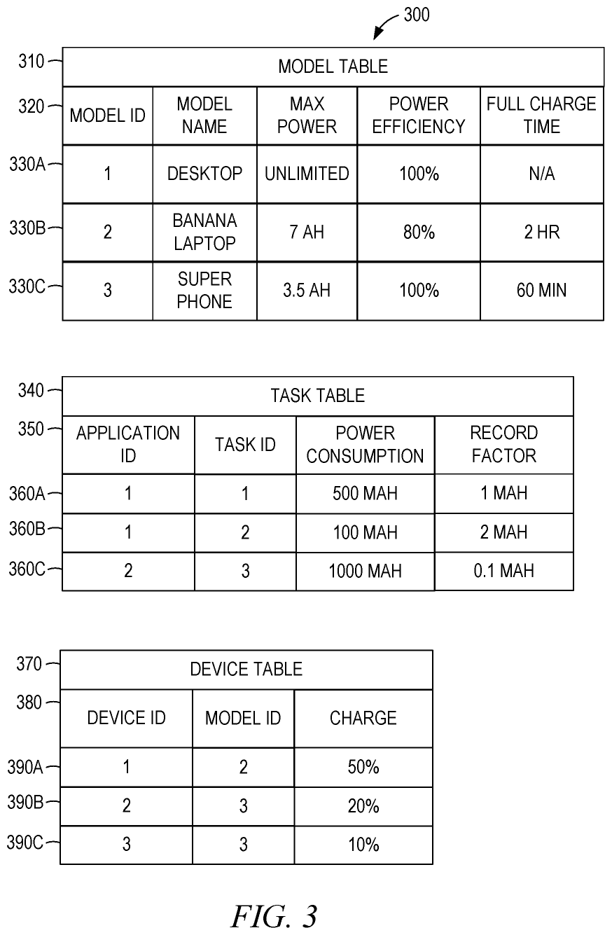

FIG. 3 is a block diagrams of a database schema 300, according to some example embodiments, suitable for use in adaptive energy management for web applications. The database schema 300 includes a model table 310, a task table 340, and a device table 370. The model table 310 includes rows 330A, 330B, and 330C of a format 320. The task table 340 includes rows 360A, 360B, and 360C of a format 350. The device table 370 includes rows 390A, 390B, and 390C of a format 380. Though only a few rows are shown in each of the database tables 310, 340, 370, data for any number of models, tasks, and devices may be stored in the database schema 300.

The format 320 of the model table 310 includes a model identifier field, a model name field, a maximum power field, a power efficiency field, and a full charge time field. Each of the rows 330A-330C stores data for a single model of device that may perform tasks. The model identifier is a unique identifier for the model. The model name is a human-readable identifier for the model. Thus, the row 330A contains data for a desktop computer, the row 330B contains data for a laptop computer, and the row 330C contains data for a smart phone. The maximum power field indicates the maximum power supply for the model when fully charged. For example, a desktop computer is plugged into a wall socket and thus has an unlimited power supply. As another example, the laptop computer of the row 330B has a battery that holds 7 Ah of charge. The smart phone of the row 330C has a battery that holds 3.5 Ah of charge. Different models of battery-powered devices may have different maximum power values.

The power efficiency field indicates the relative efficiency of the model in using power to perform tasks. For example, the laptop computer of the row 330B has an 80% power efficiency, indicating that the same amount of charge is consumed to perform 80% of the computations of the models of the other two rows, which have 100% efficiency. A power efficiency of greater than 100% is possible, as the measurement is relative to a baseline efficiency used in determining the power consumption value in the task table 340.

Different models take different amounts of time to fully charge. This is indicated in the full charge time field of the model table 310. The desktop computer of the row 330A does not use battery power, so has a not applicable (or NULL) value in this field. The laptop computer of the row 330B takes 2 hours to fully charge. The smaller battery of the smart phone of the row 330C takes only 60 minutes to fully charge.

Each row 360 of the task table 340 includes an application identifier, a task identifier, a power consumption, and a record factor as defined by the format 350. Each of the rows 360A-360C stores data for a single task. The application identifier and task identifier identify the task for which the row stores data. The power consumption field shows the amount of power consumed by the task whenever the task is performed. The record factor indicates an additional amount of power consumed for each record in the task. For example, performing the task of the row 360C on a data set comprising 10,000 records is estimated to consume 1000 mAh+(10,000 records)(0.1 mAh/record)=2,000 mAh.

The format 380 of the device table 370 includes a device identifier field, a model identifier field, and a charge field. Each of the rows 390A-390C stores data for a single client device 150. The device identifier is a unique identifier for the client device 150. The model identifier may be cross-referenced with the model table 310 to access data for the client device 150 that is the same for all client devices 150 of the same model. The charge field indicates the current charge level of the client device 150. For example, the row 390B indicates that device 2 is a model 3 device that is 20% charged. By cross-reference with the model table 310, the application server 120 may determine that device 2 has a maximum charge of 3.5 Ah, and thus currently has 0.7 Ah of charge. Accordingly, device 2 does not currently have enough charge to perform the task of the row 360C on a data set comprising 10,000 records, which would consume 2 Ah of charge.

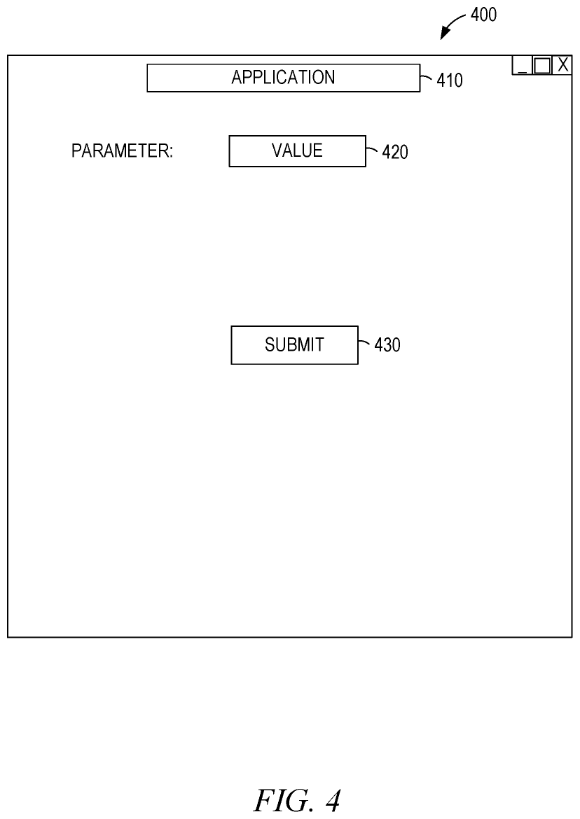

FIG. 4 is a block diagram of a user interface 400 suitable for adaptive energy management for web applications, according to some example embodiments. The user interface 400 includes a title 410, a parameter field 420, and a button 430. The user interface 400 may be generated by the application server 120A and presented via the web interface 160 of the client device 150A, all shown in FIG. 1.

The title 410 indicates that the user interface 400 is for an application. The parameter field 420 accepts input from a user. For example, an application that performs mathematical computations may accept a formula to evaluate. As another example, an application that performs business invoicing may accept an amount to invoice. For illustration purposes, the user interface 400 includes only a single parameter field 420, but practical applications may include multiple parameters and multiple screens to receive the parameters.

The button 430 may be operable to cause the evaluation of a processing request for the application based on the user input, data from the database server 130 of FIG. 1, data stored on the client device 150A, or any suitable combination thereof. In response to operation of the button 430, processing may begin on the application server 120A, the client device 150A, or any suitable combination thereof.

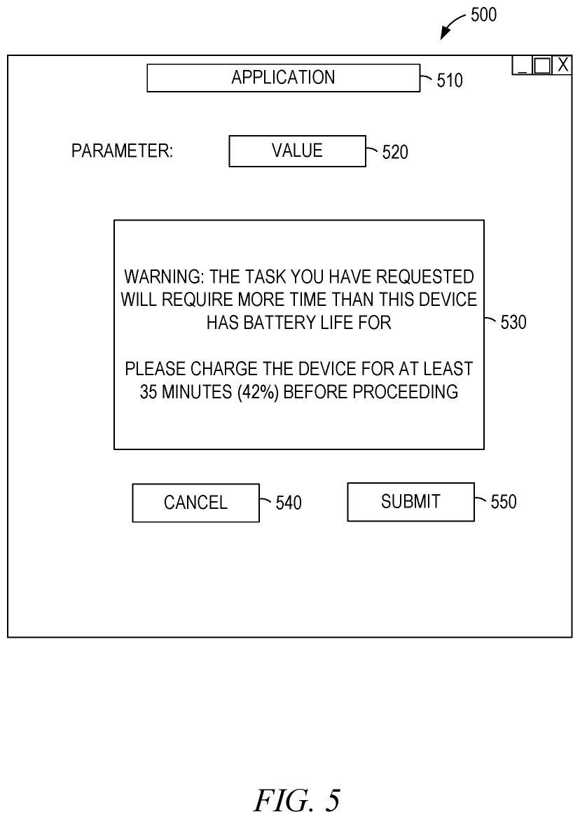

FIG. 5 is a block diagram of a user interface 500 suitable for adaptive energy management for web applications, according to some example embodiments. The user interface 500 includes a title 510, a parameter field 520, an information area 530, and buttons 540 and 550. The user interface 500 may be generated by the application server 120A and presented via the web interface 160 of the client device 150A, all shown in FIG. 1. The user interface 500 may be presented in response to operation of the button 430 of FIG. 4.

The title 510 indicates that the user interface 500 is for the same application as the user interface 400 of FIG. 4. The parameter field 520 shows the input that was received from the user in the user interface 400. The application server 120A or the client device 150A may determine that the requested processing will consume more time or power than the client device 150A has remaining battery life. Based on this determination, the user interface 500 may be presented with the information area 530. The information area 530 includes a warning that the requested task will not complete before the device loses power. A suggestion is also included, requesting the user to charge the device for an identified period of time, to charge the device to an identified charge level, to change a power source of the device, to save progress and resume the task with another device, or any suitable combination thereof. For example, the recommendation may be to plug the device into a wall socket before beginning the task. As another example, the recommendation may be to use another battery before beginning the task. As still another example, the recommendation may be to perform the task on another device.

The buttons 540 and 550 enable the user to either proceed with the requested task (button 550) or to cancel the request (button 540). In response to operation of one of the buttons 540 and 550, the task either proceeds or is canceled. Thus, by use of the user interface 500, the user is enabled to avoid beginning a task that cannot be completed. Tasks that cannot be completed waste processing and battery resources.

In response to the battery being charged for the identified duration of time, the application server 120A or the client device 150A presents a notification that the battery is sufficiently charged. Additionally or alternatively, the task may automatically be started in response to a determination that the battery now has sufficient charge to complete the task or in response to the battery being charged for the identified duration of time.

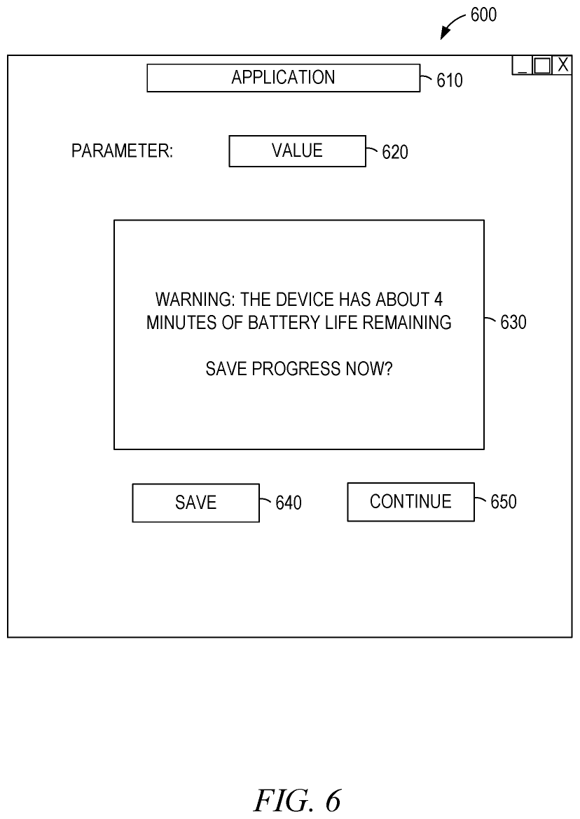

FIG. 6 is a block diagram of a user interface 600 suitable for adaptive energy management for web applications, according to some example embodiments. The user interface 600 includes a title 610, a parameter field 620, an information area 630, and buttons 640 and 650. The user interface 600 may be generated by the application server 120A and presented via the web interface 160 of the client device 150A, all shown in FIG. 1. The user interface 600 may be presented after a task is begun in response to operation of the button 550 of FIG. 5.

The title 610 indicates that the user interface 600 is for the same application as the user interface 500 of FIG. 5 and the user interface 400 of FIG. 4. The parameter field 620 shows the input that was received from the user in the user interface 400. The application server 120A or the client device 150A may determine that the battery of the client device has less than a predetermined threshold of charge remaining (e.g., less than 5 minutes or less than 5%). Based on this determination, the user interface 600 may be presented with the information area 630. The information area 630 includes a warning that the device has limited battery life remaining. A prompt is also included, asking whether the user wants to save progress. Other example prompts or recommendations include prompts to change a power source of the device, to save progress and resume the task with another device, or any suitable combination thereof. For example, the recommendation may be to plug the device into a wall socket before beginning the task. As another example, the recommendation may be to use another battery before beginning the task. As still another example, the recommendation may be to perform the task on another device.

The buttons 640 and 650 enable the user to either save the progress made on the task (button 640) or to continue processing without saving (button 650). In response to operation of the button 640, progress of the task is saved (e.g., to the client device 150A, to the application server 120A, or any suitable combination thereof) and the task resumes. In response to operation of the button 650, the task continues without saving. Thus, by use of the user interface 600, the user is enabled to save progress on a task that may not be completed. Saving the progress avoids wasting the processing and battery cycles that were spent on the task in the event that power is lost before the task completes.

In some example embodiments, the recommendation is automatically followed, either with or without presentation of the user interface 600. For example, progress may be automatically saved in response to detection that the battery life is below a predetermined threshold, progress may be automatically saved after presentation of the user interface 600 after a predetermined period of time elapses, or any suitable combination thereof.

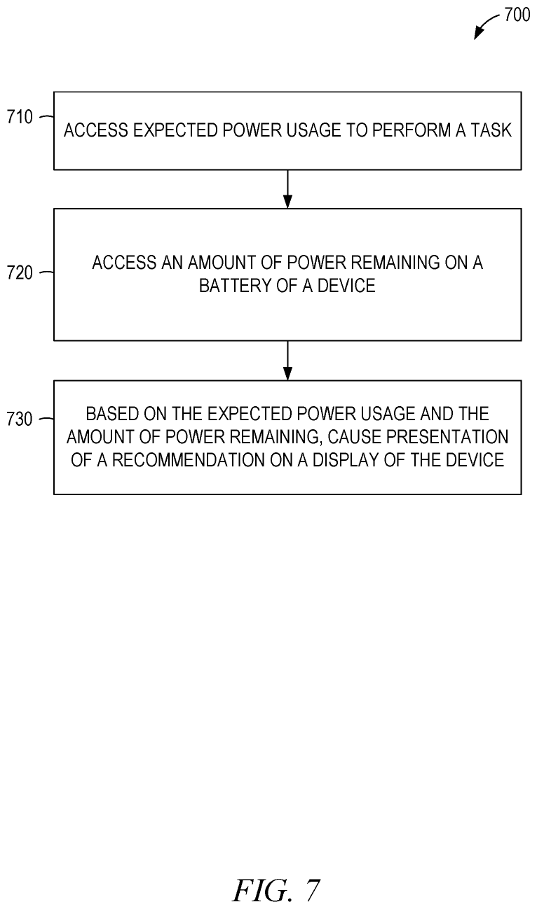

FIG. 7 is a flowchart illustrating operations of a method 700 suitable for adaptive energy management for web applications, according to some example embodiments. The method 700 includes operations 710, 720, and 730. By way of example and not limitation, the method 700 may be performed by the application server 120A or the client device 150A of FIG. 1, using the modules, databases, and user interfaces shown in FIGS. 2-6.

In operation 710, the computing requirement module 220 or the energy consumption module 230 (both of FIG. 2) of the application server 120 or the client device 150A (both of FIG. 1) accesses expected power usage to perform a task. For example, the power usage to perform the task may be stored in a database. Alternatively, the power usage to perform the task may be determined based on parameters for the task. For example, data from the task table 340 (of FIG. 3) may be accessed to determine the power consumption for the task.

The application server 120 or the client device 150A accesses, in operation 720, an amount of power remaining on a battery of a device. For example, an API may be used to request a percentage battery life remaining on the device.

In operation 730, based on the expected power usage and the amount of power remaining, the user interface module 240 causes a recommendation to be presented on a display of the device. For example, the user interface 500 of FIG. 5 may be presented based on the expected power usage exceeding the amount of power remaining. The recommendation may include an amount of time to charge the device, which may be based on the difference between the expected power usage and the amount of power remaining, a charge rate of the device, or any suitable combination thereof.

In view of the above described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a device comprising: a battery; a display; a memory that stores instructions; and one or more processors configured by the instructions to perform operations comprising: accessing expected power usage to perform a task; accessing an amount of power remaining on the battery; and based on the expected power usage and the amount of power remaining, causing presentation of a recommendation on the display.

In Example 2, the subject matter of Example 1, wherein the recommendation comprises a recommendation to charge the battery for an identified duration of time.

In Example 3, the subject matter of Example 2, wherein the operations further comprise: in response to the battery being charged for the identified duration of time, presenting a notification that the battery is sufficiently charged.

In Example 4, the subject matter of Examples 1-3, wherein the recommendation comprises a recommendation to change a power source of the device.

In Example 5, the subject matter of Example 4, wherein the recommendation to change the power source comprises a recommendation to plug the device into a wall socket.

In Example 6, the subject matter of Examples 4-5, wherein the recommendation to change the power source comprises a recommendation to use another battery.

In Example 7, the subject matter of Examples 1-6, wherein the recommendation comprises a recommendation to perform the task on another device.

Example 8 is a method comprising: accessing, by one or more processors of a device, expected power usage to perform a task; accessing, by the one or more processors, an amount of power remaining on a battery of the device; and based on the expected power usage and the amount of power remaining, causing presentation of a recommendation on a display of the device.

In Example 9, the subject matter of Example 8, wherein the recommendation comprises a recommendation to charge the battery for an identified duration of time.

In Example 10, the subject matter of Example 9 includes, in response to the battery being charged for the identified duration of time, presenting a notification that the battery is sufficiently charged.

In Example 11, the subject matter of Examples 8-10, wherein the recommendation comprises a recommendation to change a power source of the device.

In Example 12, the subject matter of Example 11, wherein the recommendation to change the power source comprises a recommendation to plug the device into a wall socket.

In Example 13, the subject matter of Examples 11-12, wherein the recommendation to change the power source comprises a recommendation to use another battery.

In Example 14, the subject matter of Examples 8-13, wherein the recommendation comprises a recommendation to perform the task on another device.

Example 15 is a non-transitory computer-readable medium that stores instructions that, when executed by one or more processors of a device, cause the one or more processors to perform operations comprising: accessing expected power usage to perform a task; accessing an amount of power remaining on a battery of the device; and based on the expected power usage and the amount of power remaining, presenting a recommendation on a display of the device.

In Example 16, the subject matter of Example 15, wherein the recommendation comprises a recommendation to charge the battery for an identified duration of time.

In Example 17, the subject matter of Example 16, wherein the operations further comprise: in response to the battery being charged for the identified duration of time, presenting a notification that the battery is sufficiently charged.

In Example 18, the subject matter of Examples 15-17, wherein the recommendation comprises a recommendation to change a power source of the device.

In Example 19, the subject matter of Example 18, wherein the recommendation to change the power source comprises a recommendation to plug the device into a wall socket.

In Example 20, the subject matter of Examples 18-19, wherein the recommendation to change the power source comprises a recommendation to use another battery.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

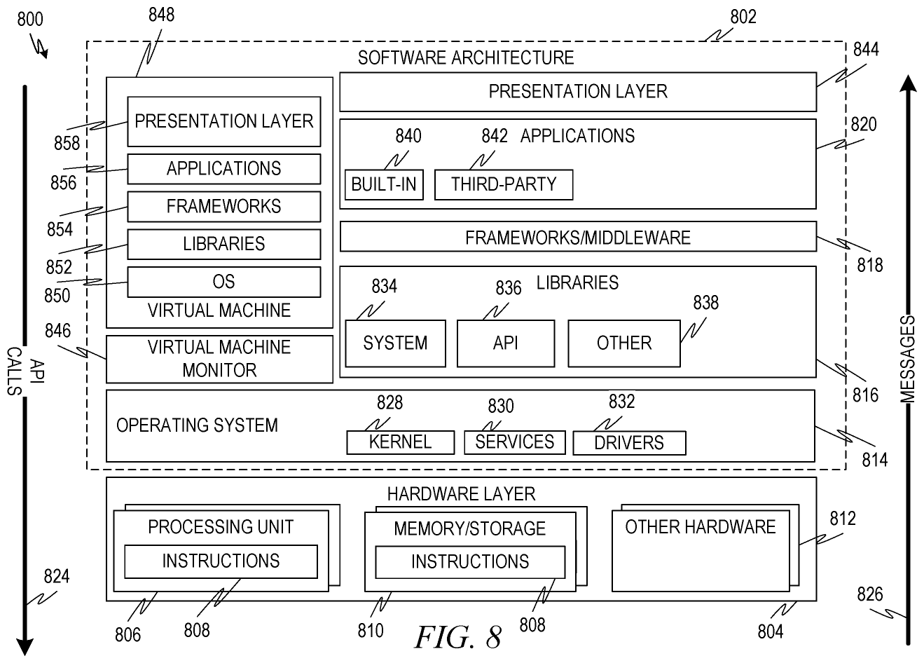

FIG. 8 is a block diagram 800 showing one example of a software architecture 802 for a computing device. The software architecture 802 may be used in conjunction with various hardware architectures, for example, as described herein. FIG. 8 is merely a non-limiting example of a software architecture and many other architectures may be implemented to facilitate the functionality described herein. A representative hardware layer 804 is illustrated and can represent, for example, any of the above referenced computing devices. In some examples, the hardware layer 804 may be implemented according to the architecture of the computer system of FIG. 8.

The representative hardware layer 804 comprises one or more processing units 806 having associated executable instructions 808. Executable instructions 808 represent the executable instructions of the software architecture 802, including implementation of the methods, modules, subsystems, and components, and so forth described herein and may also include memory and/or storage modules 810, which also have executable instructions 808. Hardware layer 804 may also comprise other hardware as indicated by other hardware 812, which represents any other hardware of the hardware layer 804, such as the other hardware illustrated as part of the software architecture 802.

In the example architecture of FIG. 8, the software architecture 802 may be conceptualized as a stack of layers where each layer provides particular functionality. For example, the software architecture 802 may include layers such as an operating system 814, libraries 816, frameworks/middleware layer 818, applications 820, and presentation layer 844. Operationally, the applications 820 and/or other components within the layers may invoke application programming interface (API) calls 824 through the software stack and access a response, returned values, and so forth illustrated as messages 826 in response to the API calls 824. The layers illustrated are representative in nature and not all software architectures have all layers. For example, some mobile or special purpose operating systems may not provide a frameworks/middleware layer 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of an interrupt and, in response, cause the software architecture 802 to pause its current processing and execute an interrupt service routine (ISR) when an interrupt is accessed.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware layer 818 may provide a higher-level common infrastructure that may be utilized by the applications 820 and/or other software components/modules. For example, the frameworks/middleware layer 818 may provide various graphic user interface (GUI) functions, high-level resource management, high-level location services, and so forth. The frameworks/middleware layer 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. Third-party applications 842 may include any of the built-in applications as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 842 may invoke the API calls 824 provided by the mobile operating system such as operating system 814 to facilitate functionality described herein.

The applications 820 may utilize built in operating system functions (e.g., kernel 828, services 830 and/or drivers 832), libraries (e.g., system libraries 834, API libraries 836, and other libraries 838), and frameworks/middleware layer 818 to create user interfaces to interact with users of the system. Alternatively, or additionally, in some systems, interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware computing device. A virtual machine is hosted by a host operating system (operating system 814) and typically, although not always, has a virtual machine monitor 846, which manages the operation of the virtual machine 848 as well as the interface with the host operating system (i.e., operating system 814). A software architecture executes within the virtual machine 848 such as an operating system 850, libraries 852, frameworks/middleware 854, applications 856 and/or presentation layer 858. These layers of software architecture executing within the virtual machine 848 can be the same as corresponding layers previously described or may be different.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 9 is a block diagram of a machine in the example form of a computer system 900 within which instructions 924 may be executed for causing the machine to perform any one or more of the methodologies discussed herein, such as presenting the user interfaces 400, 500, or 600 or performing the method 700. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation (or cursor control) device 914 (e.g., a mouse), a storage unit 916, a signal generation device 918 (e.g., a speaker), and a network interface device 920.

### Machine-Readable Medium

The storage unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting machine-readable media 922.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding, or carrying instructions 924 for execution by the machine and that cause the machine to perform any one or more of the methodologies of the present disclosure, or that is capable of storing, encoding, or carrying data structures utilized by or associated with such instructions 924. The term “machine-readable medium” shall accordingly be taken to include, but not be limited to, solid-state memories, and optical and magnetic media. Specific examples of machine-readable media 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 924 may further be transmitted or received over a communications network 926 using a transmission medium. The instructions 924 may be transmitted using the network interface device 920 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 924 for execution by the machine, and includes digital or analog communications signals or other intangible media to facilitate communication of such software.

Although specific example embodiments are described herein, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A device comprising:
a battery;
a display;
a memory that stores instructions; and
one or more processors configured by the instructions to perform operations comprising:
accessing expected power usage to perform a task;
accessing an amount of power remaining on the battery; and
based on the expected power usage and the amount of power remaining, causing presentation of a recommendation on the display.

2. The device of claim 1, wherein the recommendation comprises a recommendation to charge the battery for an identified duration of time.

3. The device of claim 2, wherein the operations further comprise:
in response to the battery being charged for the identified duration of time, presenting a notification that the battery is sufficiently charged.

4. The device of claim 1, wherein the recommendation comprises a recommendation to change a power source of the device.

5. The device of claim 4, wherein the recommendation to change the power source comprises a recommendation to plug the device into a wall socket.

6. The device of claim 4, wherein the recommendation to change the power source comprises a recommendation to use another battery.

7. The device of claim 1, wherein the recommendation comprises a recommendation to perform the task on another device.

8. A method comprising:
accessing, by one or more processors of a device, expected power usage to perform a task;
accessing, by the one or more processors, an amount of power remaining on a battery of the device; and
based on the expected power usage and the amount of power remaining, causing presentation of a recommendation on a display of the device.

9. The method of claim 8, wherein the recommendation comprises a recommendation to charge the battery for an identified duration of time.

10. The method of claim 9, further comprising:
in response to the battery being charged for the identified duration of time, presenting a notification that the battery is sufficiently charged.

11. The method of claim 8, wherein the recommendation comprises a recommendation to change a power source of the device.

12. The method of claim 11, wherein the recommendation to change the power source comprises a recommendation to plug the device into a wall socket.

13. The method of claim 11, wherein the recommendation to change the power source comprises a recommendation to use another battery.

14. The method of claim 8, wherein the recommendation comprises a recommendation to perform the task on another device.

15. A non-transitory computer-readable medium that stores instructions that, when executed by one or more processors of a device, cause the one or more processors to perform operations comprising:
accessing expected power usage to perform a task;
accessing an amount of power remaining on a battery of the device; and
based on the expected power usage and the amount of power remaining, presenting a recommendation on a display of the device.

16. The non-transitory computer-readable medium of claim 15, wherein the recommendation comprises a recommendation to charge the battery for an identified duration of time.

17. The non-transitory computer-readable medium of claim 16, wherein the operations further comprise:
in response to the battery being charged for the identified duration of time, presenting a notification that the battery is sufficiently charged.

18. The non-transitory computer-readable medium of claim 15, wherein the recommendation comprises a recommendation to change a power source of the device.

19. The non-transitory computer-readable medium of claim 18, wherein the recommendation to change the power source comprises a recommendation to plug the device into a wall socket.

20. The non-transitory computer-readable medium of claim 18, wherein the recommendation to change the power source comprises a recommendation to use another battery.
